(19) United States
(12) Patent Application Publication
(10) Pub. No.: US 2026/0339156 A1
(43) Pub. Date: Oct. 29, 2026

(54) ELECTROCHROMIC PANEL

(71) Applicant: AUO Corporation, Hsinchu City (TW)

(72) Inventors: Chin-An Lin, Hsinchu City (TW); Jen-Hao Shih, Hsinchu City (TW); Cheng-Ting Tsai, Hsinchu City (TW); Kun-Cheng Tien, Hsinchu City (TW)

(73) Assignee: AUO Corporation, Hsinchu City (TW)

(21) Appl. No.: 19/363,658

(22) Filed: Oct. 21, 2025

(30) Foreign Application Priority Data
Apr. 25, 2025 (TW) 114115747

(51) Int. Cl. G02F 1/155; G02F 1/1333; G09G 3/38

(52) U.S. Cl. CPC G02F 1/155; G02F 1/133345; G02F 1/13338; G09G 3/38

(57) ABSTRACT

An electrochromic panel includes a first conductive layer, an insulating layer, and a second conductive layer. The first conductive layer includes a first mesh electrode. The first mesh electrode has a first straight portion and a plurality of first lateral portions respectively located at two opposite sides of the first straight portion. The insulating layer is disposed on the first conductive layer and has a plurality of contact windows. The second conductive layer is disposed on the insulating layer. The second conductive layer includes a first mesh electrode. The first mesh electrode of the second conductive layer is overlapped with the plurality of first lateral portions of the first mesh electrode of the first conductive layer and electrically connected to the first mesh electrode of the first conductive layer via a portion of the plurality of contact windows.

### CROSS-REFERENCE TO RELATED APPLICATION

This application claims the priority benefit of Taiwan application serial no. 114115747, filed on Apr. 25, 2025. The entirety of the above-mentioned patent application is hereby incorporated by reference herein and made a part of this specification.

### BACKGROUND OF THE INVENTION

### Field of the Invention

The invention relates to an electrochromic panel.

### Description of Related Art

A transparent display panel refers to a display device that may provide a transparent display state so that the user may see through the transparent display panel. The transparent display panel has a display area and a transparent area, wherein the display area may provide a display image for the user to view, and the transparent area is in a transparent state to allow the user to see through the transparent area. Pixels are disposed in the display area to emit image beams toward the display surface of the transparent display panel to provide the image. Due to the influence of background light, the contrast of the transparent display panel is generally not high. To improve the contrast of the transparent display panel, an electrochromic panel may be disposed behind the transparent display panel. The electrochromic panel may be switched to a light-shielding mode to block background light, thereby improving contrast.

The electrochromic panel includes a first substrate, a second substrate disposed opposite to the first substrate, and an electrochromic layer disposed between the first substrate and the second substrate. By controlling the voltage difference between the electrodes of the first substrate and the electrodes of the second substrate, the electrochromic layer may be changed from a transparent state to a light-absorbing state, thereby switching the dimming panel to a light-shielding mode. However, when the electrochromic layer is changed from the transparent state to the light-absorbing state, the resistance thereof is also decreased. At this time, in the case that the resistance of the electrodes of the first substrate/the electrodes of the second substrate is too high, the driving current tends to flow through the portion of the electrochromic layer changed to the light-absorbing state, and does not readily flow through the other portion of the electrochromic layer not changed to the light-absorbing state, thereby causing the issue that the electrochromic panel is unable to entirely turn black.

### SUMMARY OF THE INVENTION

The invention provides an electrochromic panel with excellent performance.

An electrochromic panel of an embodiment of the invention includes a signal input element, a first base, a first conductive layer, a second conductive layer, a second base, and an electrochromic layer. The first conductive layer is disposed on the first base and electrically connected to the signal input element. The first conductive layer includes a first mesh electrode and a plurality of second mesh electrodes. The first mesh electrode has a first straight portion and a plurality of first lateral portions respectively located at two opposite sides of the first straight portion. A first end of the first straight portion is adjacent to the signal input element, and a second end of the first straight portion is connected to the plurality of first lateral portions. The plurality of second mesh electrodes are respectively located at two opposite sides of the first straight portion of the first mesh electrode of the first conductive layer. Each of the second mesh electrodes of the first conductive layer includes a second straight portion and a second lateral portion. The second straight portion is substantially parallel to the first straight portion. A first end of the second straight portion is adjacent to the signal input element. A second end of the second straight portion is connected to the second lateral portion. The plurality of second lateral portions of the plurality of second mesh electrodes of the first conductive layer are extended in opposite first direction and second direction, respectively. The first straight portion of the first mesh electrode has a width W1 in the first direction. The plurality of second straight portions of the plurality of second mesh electrodes have a width W21 and a width W22 in the first direction, respectively. W1>(W21+W22). An insulating layer is disposed on the first conductive layer and has a plurality of contact windows. The plurality of contact windows are overlapped with the first mesh electrode and the plurality of second mesh electrodes of the first conductive layer. The second conductive layer is disposed on the insulating layer. The second conductive layer includes a first mesh electrode and a second mesh electrode. The first mesh electrode of the second conductive layer is overlapped with the plurality of first lateral portions of the first mesh electrode of the first conductive layer and is electrically connected to the first mesh electrode of the first conductive layer via a portion of the plurality of contact windows. The second mesh electrode of the second conductive layer is overlapped with the plurality of second lateral portions of the plurality of second mesh electrodes of the first conductive layer and electrically connected to the second mesh electrode of the first conductive layer via a portion of the plurality of contact windows. The second base is disposed opposite to the first base. The electrochromic layer is located between the first base and the second base.

An electrochromic panel of an embodiment of the invention includes a signal input element, a first base, a first conductive layer, an insulating layer, a second conductive layer, a second base, and an electrochromic layer. The first conductive layer is disposed on the first base and electrically connected to the signal input element. The first conductive layer includes a first mesh electrode. The first mesh electrode has a first straight portion and a plurality of first lateral portions located at two opposite sides of the first straight portion. A first end of the first straight portion is adjacent to the signal input element, and a second end of the first straight portion is connected to the plurality of first lateral portions. The insulating layer is disposed on the first conductive layer and has a plurality of contact windows. The plurality of contact windows are overlapped with the first mesh electrode of the first conductive layer. The second conductive layer is disposed on the insulating layer. The second conductive layer includes a first mesh electrode. The first mesh electrode of the second conductive layer is overlapped with the plurality of first lateral portions of the first mesh electrode of the first conductive layer and electrically connected to the first mesh electrode of the first conductive layer via a portion of the plurality of contact windows. The first straight portion of the first mesh electrode of the first conductive layer is extended in a third direction. The first mesh electrode of the second conductive layer has a width y in the third direction. The first mesh electrode of the second conductive layer has a width x in the first direction. 17 cm²≤x·y≤55 cm².

### BRIEF DESCRIPTION OF THE DRAWINGS

FIG. 1 is a schematic cross-sectional view of an electrochromic panel of an embodiment of the invention.

FIG. 2 is a schematic top view of a first substrate and a signal input element of an electrochromic panel of an embodiment of the invention.

FIG. 3 is a schematic top view of a second substrate of an electrochromic panel of an embodiment of the invention.

FIG. 4 is a partially enlarged schematic view of a first substrate of an embodiment of the invention.

FIG. 5 shows the first conductive layer of FIG. 4.

FIG. 6 shows the insulating layer of FIG. 4.

FIG. 7 shows the second conductive layer of FIG. 4.

FIG. 8 shows the transparent conductive layer of FIG. 4.

FIG. 9 is a cross-sectional and enlarged schematic view of a mesh line and a mesh opening of an embodiment of the invention.

FIG. 10 is a schematic top view of an electrochromic panel of another embodiment of the invention.

FIG. 11 is a schematic top view of an electrochromic panel of another embodiment of the invention.

### DESCRIPTION OF THE EMBODIMENTS

Reference will now be made in detail to exemplary embodiments of the invention, and examples of the exemplary embodiments are illustrated in the accompanying drawings. Whenever possible, the same reference numerals are used in the drawings and the description to refer to the same or like portions.

It should be understood that when an element such as a layer, film, region, or substrate is referred to as being “on” or “connected to” another element, it may be directly on or connected to the other element, or an intermediate element may also exist. In contrast, when an element is referred to as being “directly on” or “directly connected to” another element, there are no intermediate elements. As used herein, “connected” may refer to physical and/or electrical connections. Furthermore, “electrically connected” or “coupled” may mean the presence of other elements between two elements.

As used herein, “about,” “approximately,” or “substantially” includes the stated value and an average value within an acceptable deviation range for the particular value as determined by one of ordinary skill in the art, taking into account the measurement in question and the particular amount of error associated with the measurement (i.e., the limitations of the measurement system). For example, “about” may mean within one or a plurality of standard deviations of the stated value, or within ±30%, ±20%, ±10%, or ±5%. Furthermore, as used herein, “about,” “approximately,” or “substantially” may be used to select a more acceptable deviation range or standard deviation depending on optical property, etching property, or other property, instead of applying one standard deviation to all properties.

Unless otherwise defined, all terms (including technical and scientific terms) used herein have the same meaning as commonly understood by one of ordinary skill in the art to which this invention belongs. It will be further understood that terms such as those defined in commonly used dictionaries should be interpreted as having a meaning consistent with their meaning in the context of the relevant art and the invention, and will not be interpreted as idealized or overly formal unless expressly defined as such herein.

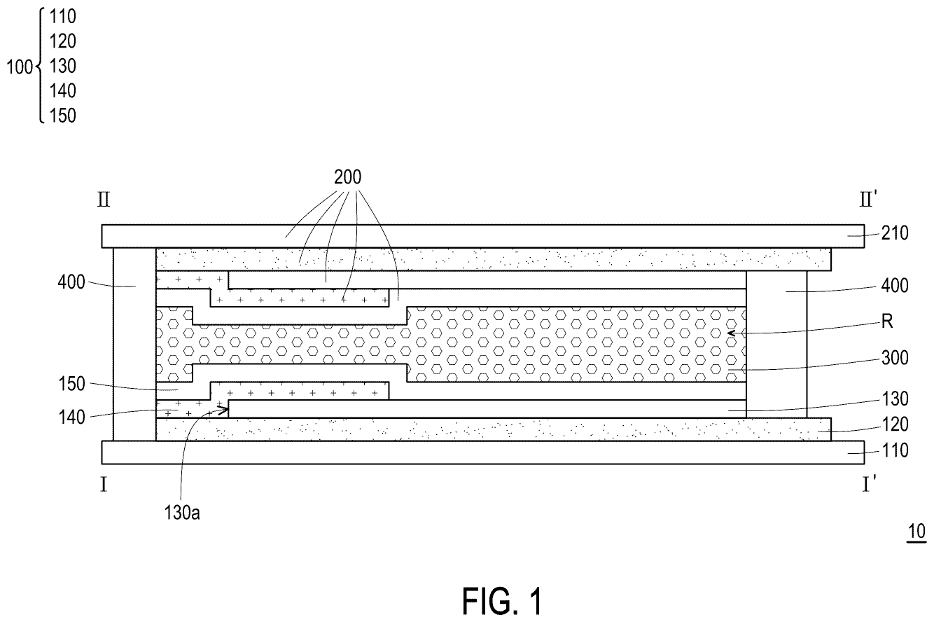

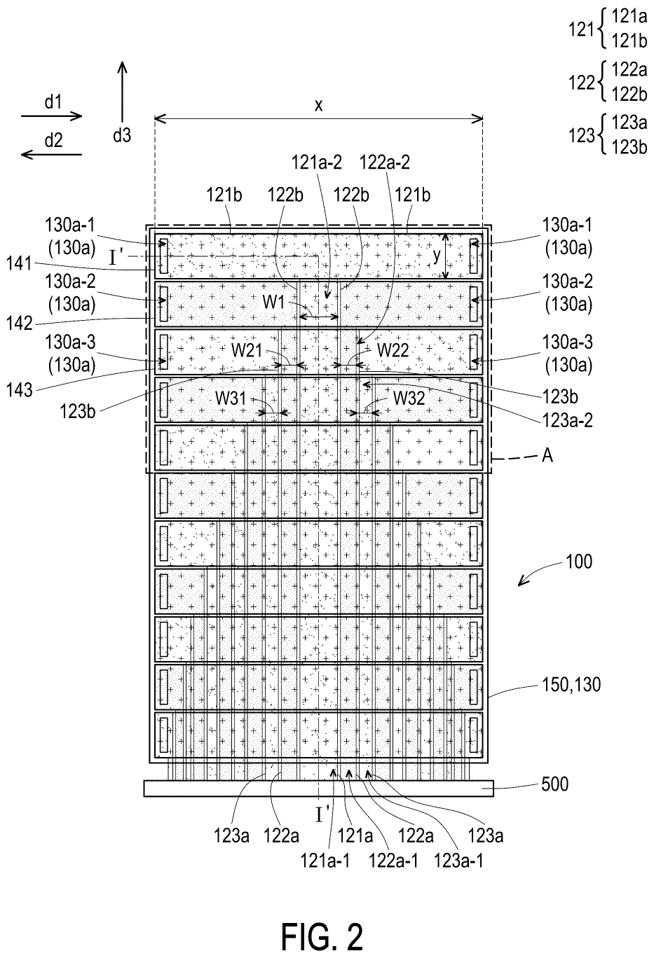

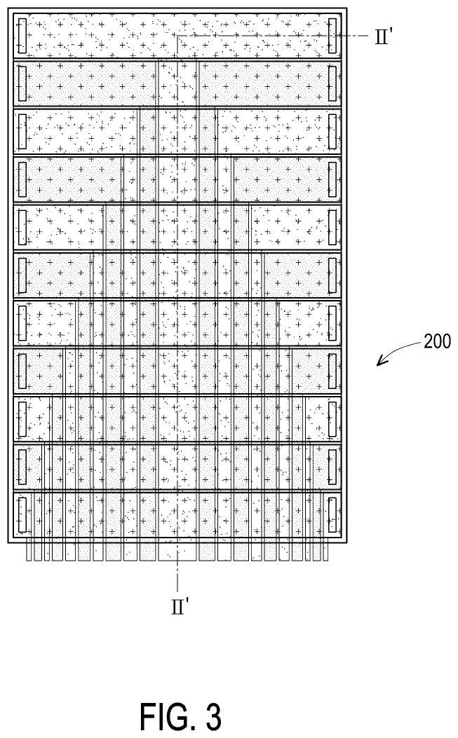

FIG. 1 is a schematic cross-sectional view of an electrochromic panel 10 of an embodiment of the invention. FIG. 2 is a schematic top view of a first substrate 100 and a signal input element 500 of the electrochromic panel 10 of an embodiment of the invention. FIG. 3 is a schematic top view of a second substrate 200 of the electrochromic panel 10 of an embodiment of the invention. FIG. 1 corresponds to the section line I-I′ of FIG. 2 and the section line II-II′ of FIG. 3 FIG. 2 omits a first base 110 of FIG. 1. FIG. 1 omits the signal input element 500 of FIG. 2.

Referring to FIG. 1, FIG. 2, and FIG. 3, the electrochromic panel 10 includes the first substrate 100, the second substrate 200, an electrochromic layer 300, and a sealant 400. The sealant 400 is connected to the first substrate 100 and the second substrate 200. The sealant 400, the first substrate 100, and the second substrate 200 together define a receiving space R. The electrochromic layer 300 is encapsulated in the receiving space R. The electrochromic layer 300 is located between the first base 110 of the first substrate 100 and a second base 210 of the second substrate 200. By controlling the voltage of the drive electrodes of at least one of the first substrate 100 and the second substrate 200, the electrochromic panel 10 may be switched between a transparent mode, a light-shielding mode, or a partially transparent and partially light-shielding mode. The structure of the electrochromic panel 10 is described in detail below with reference to the accompanying drawings.

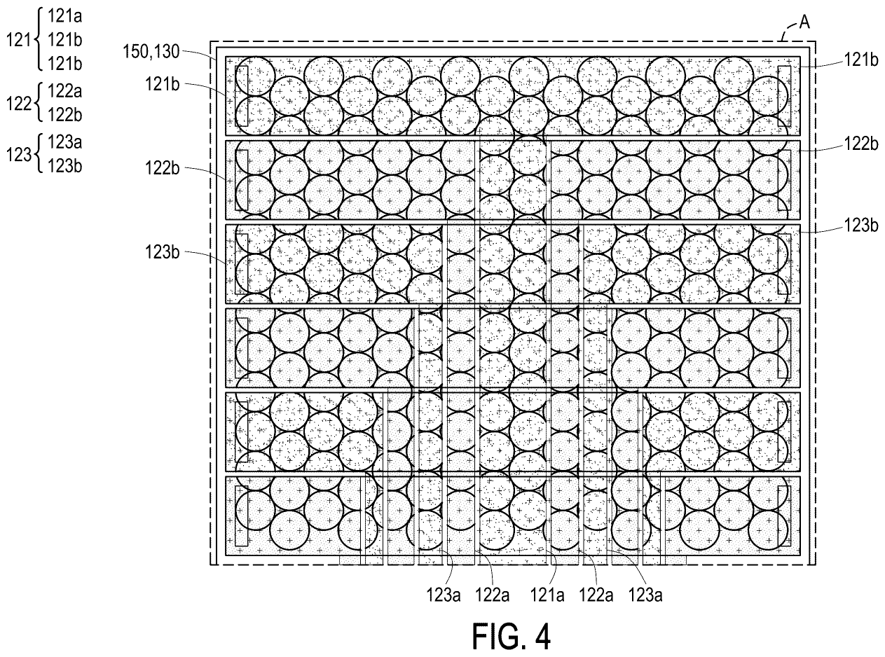

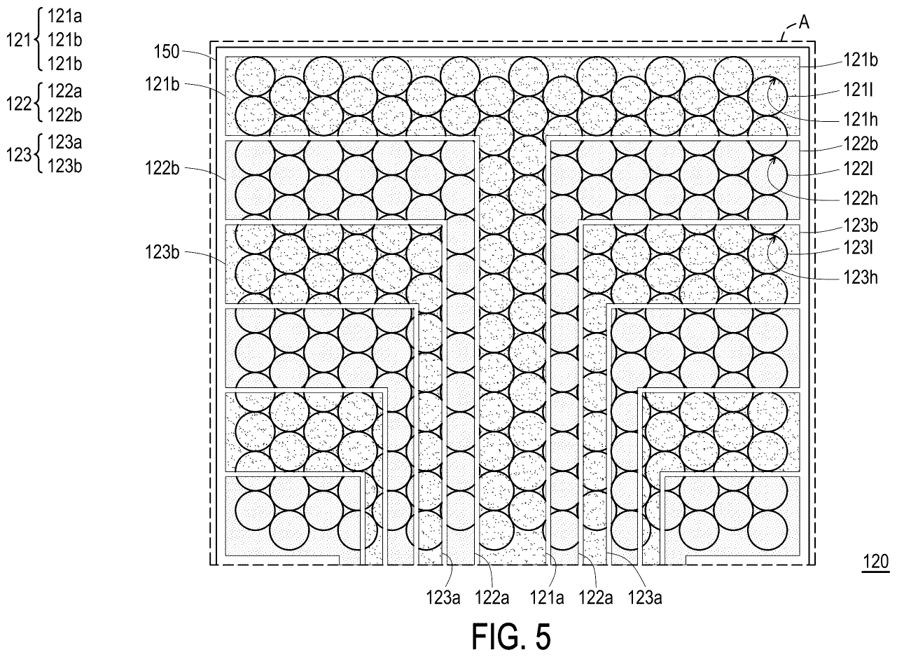

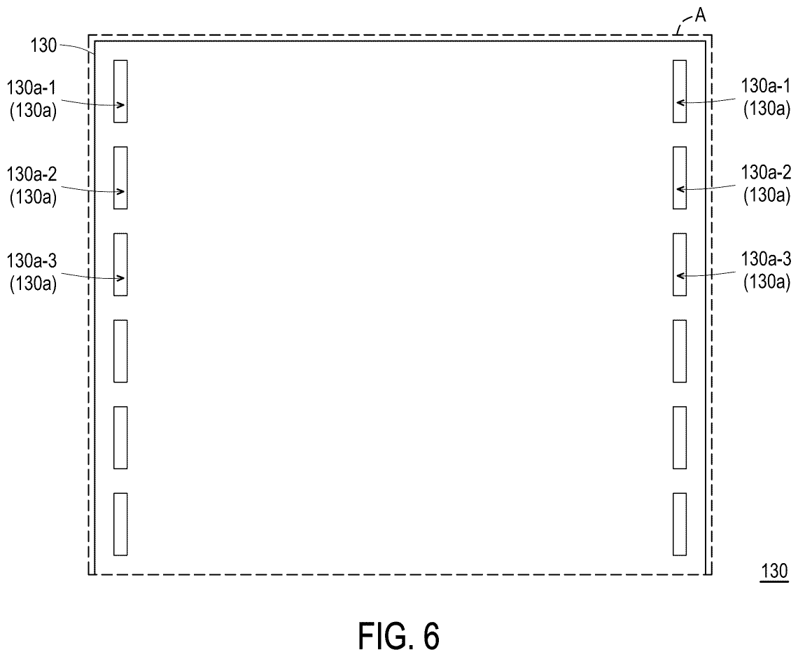

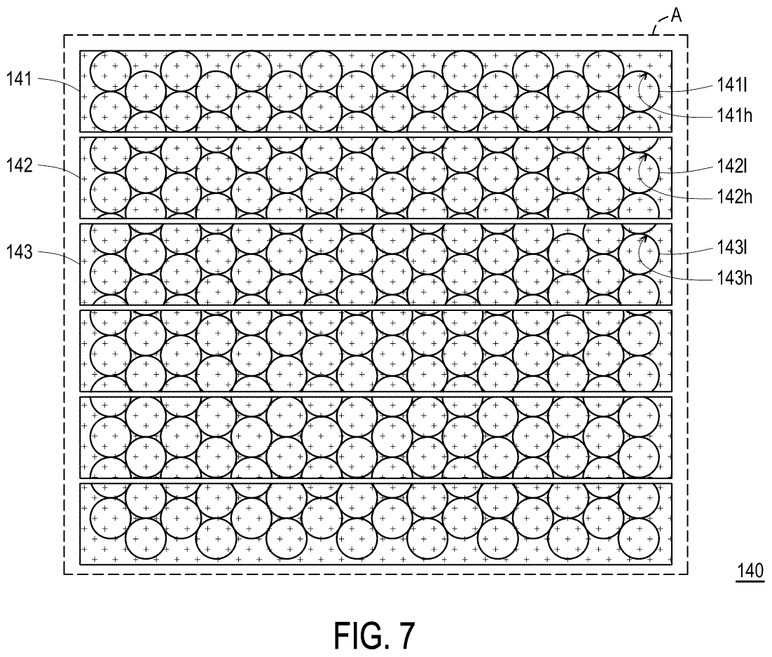

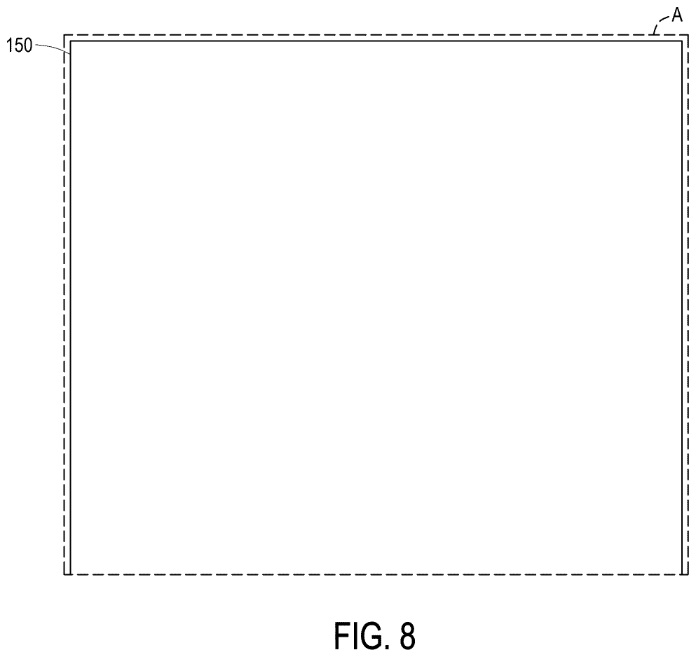

FIG. 4 is an enlarged schematic view of a portion A of the first substrate 100 of an embodiment of the invention. FIG. 4 corresponds to the portion A of FIG. 2. FIG. 5 illustrates a first conductive layer 120 of FIG. 4. FIG. 6 illustrates an insulating layer 130 of FIG. 4. FIG. 7 illustrates a second conductive layer 140 of FIG. 4. FIG. 8 illustrates the transparent conductive layer 150 of FIG. 4. It should be noted that each of the above figures illustrates the outer contours of the mesh electrodes (e.g., first mesh electrodes 121, 141, second mesh electrodes 122, 142, and third mesh electrodes 123, 143) as complete blocks. However, mesh electrodes are not completely solid electrodes. The mesh electrodes have a plurality of mesh lines and a plurality of mesh openings formed by interlacing the plurality of mesh lines (for example, the first mesh electrode 121 of FIG. 5 has a plurality of mesh lines 121l and a plurality of mesh openings 121h formed by interlacing the plurality of mesh lines 121l; the second mesh electrode 122 of FIG. 5 has a plurality of mesh lines 122l and a plurality of mesh openings 122h formed by interlacing the plurality of mesh lines 122l; the third mesh electrode 123 of FIG. 5 has a plurality of mesh lines 123l and a plurality of mesh openings 123h formed by interlacing the plurality of mesh lines 123l; the first mesh electrode 141 of FIG. 7 has a plurality of mesh lines 141l and a plurality of mesh openings 141h formed by interlacing the plurality of mesh lines 141l; the second mesh electrode 142 of FIG. 7 has a plurality of mesh lines 142l and a plurality of mesh openings 142h formed by interlacing the plurality of mesh lines 142l; the third mesh electrode 143 of FIG. 7 has a plurality of mesh lines 143l and a plurality of mesh openings 143h formed by interlacing the plurality of mesh lines 143l).

Referring to FIG. 1, FIG. 2, FIG. 4, FIG. 5, FIG. 6, FIG. 7, and FIG. 8, the first substrate 100 of the electrochromic panel 10 includes the first base 110, the first conductive layer 120 disposed on the first base 110, the insulating layer 130 disposed on the first conductive layer 120, and the second conductive layer 140 disposed on the insulating layer 130. In some embodiments, the electrochromic panel 10 further includes the transparent conductive layer 150 covering and electrically connected to the second conductive layer 140.

Referring to FIG. 1, FIG. 2, FIG. 4, and FIG. 5, the first conductive layer 120 includes one first mesh electrode 121 and a plurality of second mesh electrodes 122. The first mesh electrode 121 has a first straight portion 121a and a plurality of first lateral portions 121b located at two opposite sides of the first straight portion 121a. A first end 121a-1 of the first straight portion 121a is located adjacent to the signal input element 500. A second end 121a-2 of the first straight portion 121a is connected to the plurality of first lateral portions 121b. In some embodiments, the outer profile of the first mesh electrode 121 is generally T-shaped, but the invention is not limited thereto.

The plurality of second mesh electrodes 122 of the first conductive layer 120 are respectively located at two opposite sides of the first straight portion 121a of the first mesh electrode 121. Each of the second mesh electrodes 122 of the first conductive layer 120 includes one second straight portion 122a and one second lateral portion 122b. The second straight portion 122a is substantially parallel to the first straight portion 121a. A first end 122a-1 of the second straight portion 122a is adjacent to the signal input element 500. A second end 122a-2 of the second straight portion 122a is connected to the second lateral portion 122b. The plurality of second lateral portions 122b of the plurality of second mesh electrodes 122 are extended in opposite first direction d1 and second direction d2, respectively. In some embodiments, the outer profile of each of the second mesh electrodes 122 is substantially an inverted L-shape, and the outer profiles of the plurality of second mesh electrodes 122 are substantially mirror images of the first straight portion 121a, but the invention is not limited thereto.

In some embodiments, the first conductive layer 120 further includes a plurality of third mesh electrodes 123 respectively located adjacent to the plurality of second mesh electrodes 122 of the first conductive layer 120. The plurality of second mesh electrodes 122 are located between the first mesh electrode 121 and the plurality of third mesh electrodes 123. Each of the third mesh electrodes 123 includes one third straight portion 123a and one third lateral portion 123b. The third straight portion 123a is substantially parallel to the first straight portion 121a. A first end 123a-1 of the third straight portion 123a is adjacent to the signal input element 500. A second end 123a-2 of the third straight portion 123a is connected to the third lateral portion 123b. The plurality of third lateral portions 123b of the plurality of third mesh electrodes 123 are extended in the opposite first direction d1 and second direction d2, respectively. In some embodiments, the outer profile of each of the third mesh electrodes 123 is substantially an inverted L-shape, and the outer profiles of the plurality of third mesh electrodes 123 are substantially mirror images of the first straight portion 121a, but the invention is not limited thereto.

The first conductive layer 120 is electrically connected to the signal input element 500. Specifically, in some embodiments, the first end 121a-1 of the first straight portion 121a of one first mesh electrode 121 of the first conductive layer 120, the plurality of first ends 122a-1 of the plurality of second straight portions 122a of the plurality of second mesh electrodes 122 of the first conductive layer 120, and the plurality of first ends 123a-1 of the plurality of third straight portions 123a of the plurality of third mesh electrodes 123 of the first conductive layer 120 are connected to the signal input element 500. In other words, the first end 121a-1 of the first straight portion 121a of the first mesh electrode 121, the plurality of first ends 122a-1 of the plurality of second straight portions 122a of the plurality of second mesh electrodes 122, and the plurality of first ends 123a-1 of the plurality of third straight portions 123a of the plurality of third mesh electrodes 123 are signal feeding ends.

In some embodiments, the material of the first conductive layer 120 has the characteristics of being opaque and having low resistance. For example, the material of the first conductive layer 120 may be metal, but the invention is not limited thereto.

Referring to FIG. 1, FIG. 2, FIG. 4, and FIG. 6, the insulating layer 130 has a plurality of contact windows 130a. The plurality of contact windows 130a are overlapped with one first mesh electrode 121 and a plurality of second mesh electrodes 122 of the first conductive layer 120. In some embodiments, the plurality of contact windows 130a are also overlapped with the plurality of third mesh electrodes 123 of the first conductive layer 120. Specifically, in some embodiments, the plurality of contact windows 130a include a plurality of first contact windows 130a-1 and a plurality of second contact windows 130a-2. The plurality of first contact windows 130a-1 are respectively overlapped with the plurality of first lateral portions 121b of the first mesh electrode 121, and the plurality of second contact windows 130a-2 are respectively overlapped with the plurality of second lateral portions 122b of the plurality of second mesh electrodes 122. In some embodiments, the plurality of contact windows 130a further include a plurality of third contact windows 130a-3 respectively overlapped with the plurality of third lateral portions 123b of the plurality of third mesh electrodes 123.

In some embodiments, the material of the insulating layer 130 may be inorganic material (e.g., silicon oxide, silicon nitride, silicon oxynitride, or a stacked layer of at least two of the materials), an organic material, or a combination thereof.

Referring to FIG. 1, FIG. 2, FIG. 4, FIG. 5, and FIG. 7, the second conductive layer 140 includes the first mesh electrode 141 and the second mesh electrode 142. The first mesh electrode 141 of the second conductive layer 140 is overlapped with the plurality of first lateral portions 121b of the first mesh electrode 121 of the first conductive layer 120. The second mesh electrode 142 of the second conductive layer 140 is overlapped with the plurality of second lateral portions 122b of the plurality of second mesh electrodes 122 of the first conductive layer 120 and spans the first straight portion 121a of the first mesh electrode 121 of the first conductive layer 120. In some embodiments, the second conductive layer 140 further includes the third mesh electrode 143. The third mesh electrode 143 of the second conductive layer 140 is overlapped with the plurality of third lateral portions 123b of the plurality of third mesh electrodes 123 of the first conductive layer 120, and spans the first straight portion 121a of the first mesh electrode 121 of the first conductive layer 120 and the plurality of second straight portions 122a of the plurality of second mesh electrodes 122 of the first conductive layer 120.

In some embodiments, the material of the second conductive layer 140 has the characteristics of being opaque and having low resistance. For example, the material of the second conductive layer 140 may be metal, but the invention is not limited thereto.

Referring to FIG. 4, FIG. 5, and FIG. 7, in some embodiments, the mesh lines 141l and the mesh openings 141h of the first mesh electrode 141 of the second conductive layer 140 are substantially aligned with the mesh lines 121l and the mesh openings 121h of the first lateral portions 121b of the first mesh electrode 121 of the first conductive layer 120. The mesh lines 141l of the first mesh electrode 141 of the second conductive layer 140 are substantially overlapped with the mesh lines 121l of the first lateral portions 121b of the first mesh electrode 121 of the first conductive layer 120. In some embodiments, the mesh lines 142l and the mesh openings 142h of the second mesh electrode 142 of the second conductive layer 140 are substantially aligned with the mesh lines 122l and the mesh openings 122h of the second lateral portions 122b of the second mesh electrode 122 of the first conductive layer 120. The mesh lines 142l of the second mesh electrode 142 of the second conductive layer 140 are substantially overlapped with the mesh lines 122l of the second lateral portions 122b of the second mesh electrode 122 of the first conductive layer 120. In some embodiments, the mesh lines 143l and the mesh openings 143h of the third mesh electrode 143 of the second conductive layer 140 are substantially aligned with the mesh lines 123l and the mesh openings 123h of the third lateral portions 123b of the third mesh electrode 123 of the first conductive layer 120. The mesh lines 143l of the third mesh electrode 143 of the second conductive layer 140 are substantially overlapped with the mesh lines 123l of the third lateral portions 123b of the third mesh electrode 123 of the first conductive layer 120.

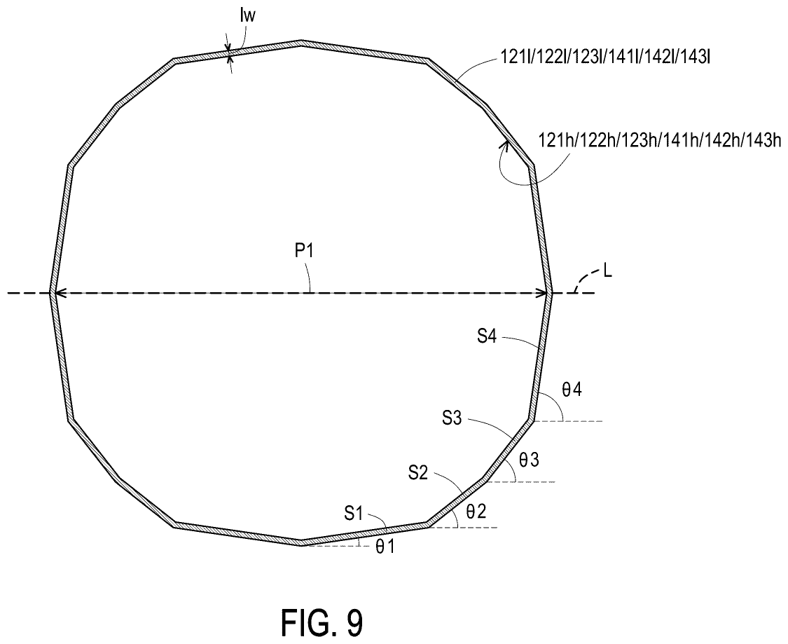

FIG. 9 is a cross-sectional and enlarged schematic view of the mesh lines 121l/122l/123l/141l/142l/143l and the mesh openings 121h/122h/123h/141h/142h/143h of an embodiment of the invention. Referring to FIG. 5, FIG. 7, and FIG. 9, in some embodiments, the mesh lines 121l/122l/123l/141l/142l/143l include a first segment S1, a second segment S2, a third segment S3, and a fourth segment S4 defining the mesh openings 121h/122h/123h/141h/142h/143h and serially connected to each other. The first segment S1, the second segment S2, the third segment S3, and the fourth segment S4 have a first angle θ1, a second angle θ2, a third angle θ3, and a fourth angle θ4 having a reference line L, respectively, and θ4>θ3>θ2>θ1. Accordingly, the intensity of diffracted light in the horizontal and vertical directions may be reduced, thereby improving visual effects.

For example, in some embodiments, one mesh line 121l/122l/123l/141l/142l/143l defining one mesh opening 121h/122h/123h/141h/142h/143h may optionally form a hexadecagon, and the reference line L may be a straight line passing through two opposite corners of the hexadecagon, but the invention is not limited thereto. In an embodiment, θ4=81.7°±2°, θ3=51.6°±2°, θ2=38.3°±2°, and θ1=8.3°±2°, but the invention is not limited thereto.

In some embodiments, the plurality of mesh openings 121h/122h/123h/141h/142h/143h of the electrochromic panel 10 have a mesh opening arrangement period P1. The plurality of pixels (not shown) of one transparent display panel (not shown) overlapped with the electrochromic panel 10 have a pixel arrangement period (not shown). The mesh opening arrangement period P1 may be greater than twice or more of the pixel arrangement period to prevent interference between the electrochromic panel 10 and the transparent display panel producing noticeable Murray fringes.

Referring to FIG. 1, FIG. 5, FIG. 7, and FIG. 9, in some embodiments, the area coverage of the first base 110 by the mesh lines 121l/122l/123l/141l/142l/143l may be less than 4%. In some embodiments, a line width lw of the mesh lines 121l/122l/123l/141l/142l/143l may vary with the mesh opening arrangement period P1. Specifically, the greater the mesh opening arrangement period P1, the wider the line width lw of the mesh lines 121l/122l/123l/141l/142l/143l may be. In some embodiments, the line width lw of the mesh lines 121l/122l/123l/141l/142l/143l may fall within a range of 8 μm to 30 μm.

Referring to FIG. 1, FIG. 2, FIG. 4, and FIG. 8, the transparent conductive layer 150 is electrically connected to the second conductive layer 140 via the contact windows 130a. In some embodiments, the transparent conductive layer 150 may optionally be a single piece. The entire transparent conductive layer 150 may be electrically connected to the first mesh electrode 141, the second mesh electrode 142, and the third mesh electrode 143 of the second conductive layer 140 via the plurality of first contact windows 130a-1, the plurality of second contact windows 130a-2, and the plurality of third contact windows 130a-3. However, the invention is not limited thereto. In other embodiments, the transparent conductive layer 150 may also be divided into a plurality of blocks.

For example, in some embodiments, the material of the transparent conductive layer 150 includes metal oxide, such as indium tin oxide, indium zinc oxide, aluminum tin oxide, aluminum zinc oxide, indium germanium zinc oxide, other suitable oxides, or a stacked layer of at least two of the above, but the invention is not limited thereto.

Referring to FIG. 2, it should be noted that the first straight portion 121a of the first mesh electrode 121 has a width W1 in the first direction d1, and the plurality of second straight portions 122a of the plurality of second mesh electrodes 122 have a width W21 and a width W22 in the first direction d1, respectively, and W1>(W21+W22). In some embodiments, the plurality of third straight portions 123a of the plurality of third mesh electrodes 123 of the first conductive layer 120 have a width W31 and a width W32 in the first direction d1, respectively, and W21+W22>W31+W32.

Thus, although the distance between the first lateral portion 121b of the first mesh electrode 121 of the first conductive layer 120 and the signal feeding end, the distance between the second lateral portion 122b of the second mesh electrode 122 of the first conductive layer 120 and the signal feeding end, and the distance between the third lateral portion 123b of the third mesh electrode 123 of the first conductive layer 120 and the signal feeding end are different, the first mesh electrode 121, the plurality of second mesh electrodes 122, and the plurality of third mesh electrodes 123 of the first conductive layer 120 may still have the same or similar resistance values, thereby facilitating switching of the electrochromic panel 10. Furthermore, the first mesh electrode 121, the second mesh electrode 122, and the third mesh electrode 123 may adopts the same feed voltage (i.e., the first end 121a-1 of the first straight portion 121a of the first mesh electrode 121, the plurality of first ends 122a-1 of the plurality of second straight portions 122a of the plurality of second mesh electrodes 122, and the plurality of first ends 123a-1 of the plurality of third straight portions 123a of the plurality of third mesh electrodes 123 have the same potential), thereby reducing the development cost of the signal input device 500.

In some embodiments, the resistance value of the first mesh electrode 121 of the first conductive layer 120 is R1, the resistance value of the plurality of second mesh electrodes 122 of the first conductive layer 120 is R2, and

$$\frac{\vert R 1 - R 2 \vert}{R 1} < 15 \% .$$

In some embodiments, the resistance value of the plurality of second mesh electrodes 122 of the first conductive layer 120 is R2, the resistance value of the plurality of third mesh electrodes 123 of the first conductive layer 120 is R3, and

$$\frac{\vert R 2 - R 3 \vert}{R 2} < 15 \% .$$

In some embodiments, the resistance value R1, the resistance value R2, and the resistance value R3 are less than the resistance value of the electrochromic layer 300 when turning black.

Referring to FIG. 2 and FIG. 7, in some embodiments, the first straight portion 121a of the first mesh electrode 121 of the first conductive layer 120 is extended substantially in a third direction d3. The first mesh electrode 141 of the second conductive layer 140 has a width y in the third direction d3. The first mesh electrode 141 of the second conductive layer 140 has a width x in the first direction d1, 17 cm²≤x·y≤55 cm², the electrochromic layer 300 has a sheet resistance

$${R}_{E C} ( \frac{Ohm}{S Q} ) , and 20 \frac{Ohm}{S Q} \leq {R}_{E C} \leq 100 \frac{Ohm}{S Q} .$$

Consequently, the electrochromic panel 10 may have better color change performance, so that the electrochromic panel 10 may have a larger transmittance difference between the enabled and disabled states.

For example, in some embodiments, when the width y of the first mesh electrode 141 of the second conductive layer 140 in the third direction d3 is 3 cm and the width x of the first mesh electrode 141 of the second conductive layer 140 in the first direction d1 is 18 cm, the transmittance difference of the electrochromic panel 10 may reach 3.418. In addition, the response time of turning on the electrochromic panel 10 may be shortened to 8 seconds, and the response time of turning off the electrochromic panel 10 may be shortened to 10 seconds. The power consumption of the electrochromic panel 10 may be reduced to 1.8 watts, and the life times of the electrochromic panel 10 may be increased to more than 12,000 times.

Referring to FIG. 1, FIG. 2, and FIG. 3, in some embodiments, the second substrate 200 of the electrochromic panel 10 may optionally have a structure identical or similar to that of the first substrate 100. For the structure of the second substrate 200, reference may be made to the above description of the structure of the first substrate 100, and is not repeated herein.

It should be noted that the following embodiments adopt the same reference numerals and some of the contents of the previous embodiments, wherein the same reference numerals are used to represent the same or similar elements, and the description of the same technical contents is omitted. For the description of the omitted portions, reference may be made to the previous embodiments, and is not repeated in the following embodiments.

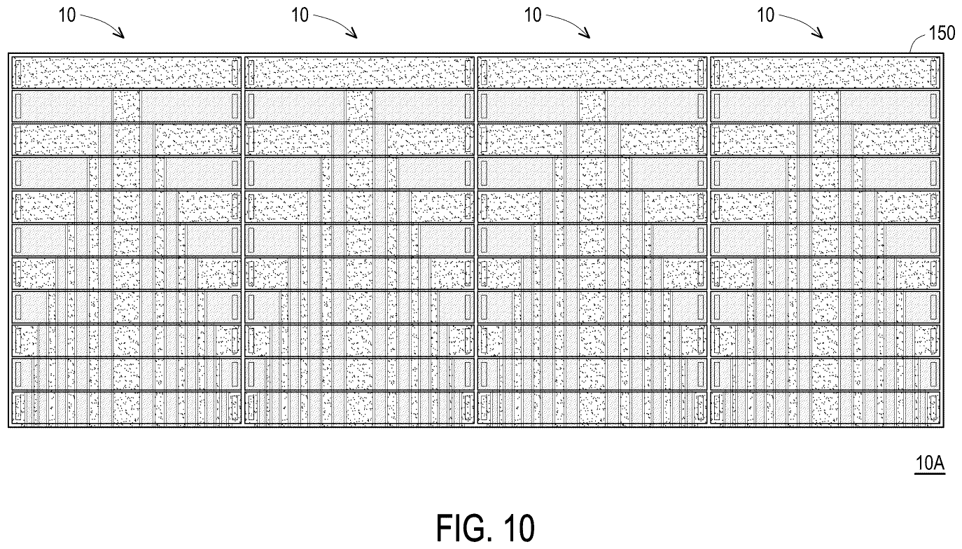

FIG. 10 is a schematic top view of an electrochromic panel 10A of another embodiment of the invention. The electrochromic panel 10A in FIG. 10 may include a plurality of electrochromic panels 10, as shown in FIG. 1, arranged in a row. The electrochromic panel 10A of FIG. 10 is, for example, a 30-inch electrochromic panel. In the embodiment of FIG. 10, the plurality of electrochromic panels 10 may optionally share a common transparent conductive layer 150, but the invention is not limited thereto.

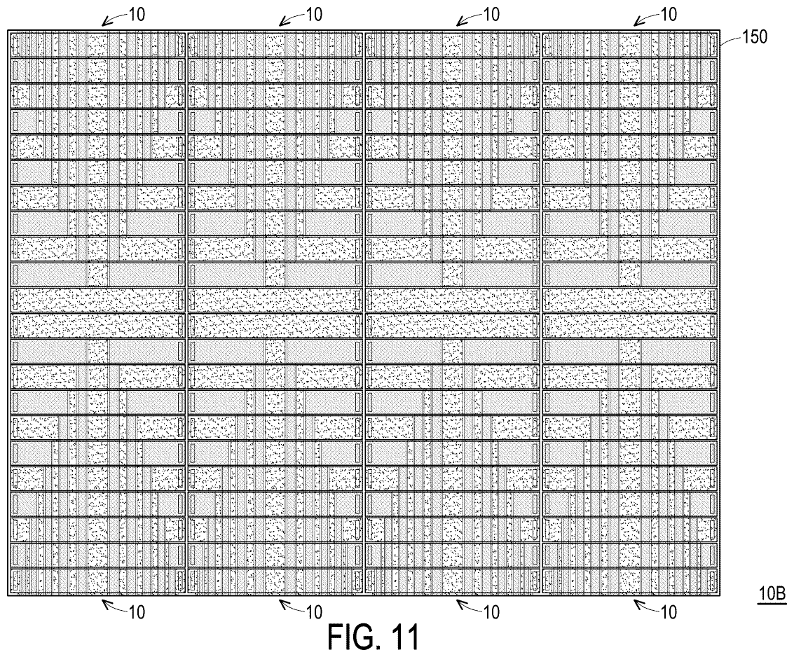

FIG. 11 is a schematic top view of an electrochromic panel 10B of another embodiment of the invention. The electrochromic panel 10B of FIG. 11 may include a 5 plurality of electrochromic panels 10, as shown in FIG. 1, arranged in a plurality of columns and a plurality of rows. The electrochromic panel 10B of FIG. 11 is, for example, a 60-inch electrochromic panel. In the embodiment of FIG. 11, the plurality of electrochromic panels 10 may optionally share a common transparent conductive layer 150, but the invention is not limited thereto.

What is claimed is:

1. An electrochromic panel, comprising:
a signal input element;
a first base;
a first conductive layer disposed on the first base and electrically connected to the signal input element, wherein the first conductive layer comprises:
a first mesh electrode having a first straight portion and a plurality of first lateral portions located at two opposite sides of the first straight portion, wherein a first end of the first straight portion is adjacent to the signal input element, and a second end of the first straight portion is connected to the first lateral portions; and
a plurality of second mesh electrodes respectively located at two opposite sides of the first straight portion of the first mesh electrode of the first conductive layer, wherein each of the second mesh electrodes of the first conductive layer comprises a second straight portion and a second lateral portion, the second straight portion is substantially parallel to the first straight portion, a first end of the second straight portion is adjacent to the signal input element, and a second end of the second straight portion is connected to the second lateral portion, and the plurality of second lateral portions of the second mesh electrodes of the first conductive layer are extended in opposite first direction and second direction, respectively;
the first straight portion of the first mesh electrode has a width W1 in the first direction, and the second straight portions of the second mesh electrodes respectively have a width W21 and a width W22 in the first direction, and W1>(W21+W22);
an insulating layer disposed on the first conductive layer and having a plurality of contact windows, wherein the contact windows are overlapped with the first mesh electrode and the second mesh electrodes of the first conductive layer;
a second conductive layer disposed on the insulating layer, wherein the second conductive layer comprises:
a first mesh electrode, wherein the first mesh electrode of the second conductive layer is overlapped with the first lateral portions of the first mesh electrode of the first conductive layer and electrically connected to the first mesh electrode of the first conductive layer via a portion of the contact windows; and
a second mesh electrode, wherein the second mesh electrode of the second conductive layer is overlapped with the second lateral portions of the second mesh electrodes of the first conductive layer and electrically connected to the second mesh electrode of the first conductive layer via a portion of the contact windows;
a second base disposed opposite to the first base; and
an electrochromic layer located between the first base and the second base.

2. The electrochromic panel of claim 1, wherein the first conductive layer further comprises:
a plurality of third mesh electrodes respectively located adjacent to the second mesh electrodes of the first conductive layer, wherein the second mesh electrodes of the first conductive layer are located between the first mesh electrode of the first conductive layer and the third mesh electrodes of the first conductive layer, each of the third mesh electrodes of the first conductive layer comprises a third straight portion and a third lateral portion, the third straight portion is substantially parallel to the first straight portion, a first end of the third straight portion is adjacent to the signal input element, a second end of the third straight portion is connected to the third lateral portion, and the plurality of third lateral portions of the third mesh electrodes of the first conductive layer are extended in the opposite first direction and second direction, respectively;
the third straight portions of the third mesh electrodes of the first conductive layer respectively have a width W31 and a width W32 in the first direction, and W21+W22>W31+W32.

3. The electrochromic panel of claim 1, wherein a resistance value of the first mesh electrode of the first conductive layer is R1, a resistance value of the second mesh electrodes of the first conductive layer is R2, and
$$\frac{\vert R 1 - R 2 \vert}{R 1} < 15 \% .$$

4. The electrochromic panel of claim 1, wherein the first end of the first straight portion of the first mesh electrode of the first conductive layer and the plurality of first ends of the second straight portions of the second mesh electrodes of the first conductive layer have a same potential.

5. The electrochromic panel of claim 1, wherein the first straight portion of the first mesh electrode of the first conductive layer is extended in a third direction, the first mesh electrode of the second conductive layer has a width y in the third direction, the first mesh electrode of the second conductive layer has a width x in the first direction, 17 cm²≤x·y≤55 cm², the electrochromic layer has a sheet resistance value R_{EC}, and
$$20 \frac{Ohm}{S Q} \leq {R}_{E C} \leq 100 \frac{Ohm}{S Q} .$$

6. An electrochromic panel, comprising:
a signal input element;
a first base;
a first conductive layer disposed on the first base and electrically connected to the signal input element, wherein the first conductive layer comprises:
a first mesh electrode having a first straight portion and a plurality of first lateral portions located at two opposite sides of the first straight portion, wherein a first end of the first straight portion is adjacent to the signal input element, and a second end of the first straight portion is connected to the first lateral portions;
a plurality of second mesh electrodes respectively located at two opposite sides of the first straight portion of the first mesh electrode of the first conductive layer, wherein each of the second mesh electrodes of the first conductive layer comprises a second straight portion and a second lateral portion, the second straight portion is substantially parallel to the first straight portion, a first end of the second straight portion is adjacent to the signal input element, a second end of the second straight portion is connected to the second lateral portion, and the plurality of second lateral portions of the second mesh electrodes of the first conductive layer are extended in opposite first direction and second direction, respectively;
an insulating layer disposed on the first conductive layer and having a plurality of contact windows, wherein the contact windows are overlapped with the first mesh electrode of the first conductive layer;
a second conductive layer disposed on the insulating layer, wherein the second conductive layer comprises:
a first mesh electrode, wherein the first mesh electrode of the second conductive layer is overlapped with the first lateral portions of the first mesh electrode of the first conductive layer and electrically connected to the first mesh electrode of the first conductive layer via a portion of the contact windows, the first straight portion of the first mesh electrode of the first conductive layer is extended in a third direction, the first mesh electrode of the second conductive layer has a width y in the third direction, the first mesh electrode of the second conductive layer has a width x in the first direction, and 17 cm²≤x·y≤55 cm²;
a second base disposed opposite to the first base; and
an electrochromic layer disposed between the first base and the second base.

7. The electrochromic panel of claim 6, wherein the electrochromic layer has a sheet resistance value R_{EC}, and
$$20 \frac{Ohm}{S Q} \leq {R}_{E C} \leq 100 \frac{Ohm}{S Q} .$$

8. The electrochromic panel of claim 6, wherein a resistance value of the first mesh electrode of the first conductive layer is R1, a resistance value of the second mesh electrodes of the first conductive layer is R2, and
$$\frac{\vert R 1 - R 2 \vert}{R 1} < 15 \% .$$

9. The electrochromic panel of claim 6, wherein the first end of the first straight portion of the first mesh electrode of the first conductive layer and the plurality of first ends of the second straight portions of the second mesh electrodes of the first conductive layer have a same potential.

10. An electrochromic panel, comprising:
a signal input element;
a first base;
a first conductive layer disposed on the first base and electrically connected to the signal input element, wherein the first conductive layer comprises:
a first mesh electrode having a first straight portion and a plurality of first lateral portions located at two opposite sides of the first straight portion, wherein a first end of the first straight portion is adjacent to the signal input element, and a second end of the first straight portion is connected to the first lateral portions; and
a plurality of second mesh electrodes respectively located at two opposite sides of the first straight portion of the first mesh electrode of the first conductive layer, in wherein each of the second mesh electrodes of the first conductive layer comprises a second straight portion and a second lateral portion, the second straight portion is substantially parallel to the first straight portion, a first end of the second straight portion is adjacent to the signal input element, a second end of the second straight portion is connected to the second lateral portion, and the plurality of second lateral portions of the second mesh electrodes of the first conductive layer are extended in opposite first direction and second direction, respectively;
the first straight portion of the first mesh electrode has a width W1 in the first direction, and the second straight portions of the second mesh electrodes have a width W21 and a width W22 in the first direction respectively;
an insulating layer disposed on the first conductive layer and having a plurality of contact windows, wherein the contact windows are overlapped with the first mesh electrode and the second mesh electrodes of the first conductive layer;
a second conductive layer disposed on the insulating layer, wherein the second conductive layer comprises:
a first mesh electrode, wherein the first mesh electrode of the second conductive layer is overlapped with the first lateral portions of the first mesh electrode of the first conductive layer and electrically connected to the first mesh electrode of the first conductive layer via a portion of the contact windows; and
a second mesh electrode, wherein the second mesh electrode of the second conductive layer is overlapped with the second lateral portions of the second mesh electrodes of the first conductive layer and electrically connected to the second mesh electrode of the first conductive layer via a portion of the contact windows;
a second base disposed opposite to the first base; and
an electrochromic layer located between the first base and the second base;
wherein the first end of the first straight portion of the first mesh electrode of the first conductive layer and the plurality of first ends of the second straight portions of the second mesh electrodes of the first conductive layer have a same potential.

11. The electrochromic panel of claim 10, wherein the first conductive layer further comprises:
a plurality of third mesh electrodes respectively located adjacent to the second mesh electrodes of the first conductive layer, wherein the second mesh electrodes of the first conductive layer are located between the first mesh electrode of the first conductive layer and the third mesh electrodes of the first conductive layer, each of the third mesh electrodes of the first conductive layer comprises a third straight portion and a third lateral portion, the third straight portion is substantially parallel to the first straight portion, a first end of the third straight portion is adjacent to the signal input element, and a second end of the third straight portion is connected to the third lateral portion, and the plurality of third lateral portions of the third mesh electrodes of the first conductive layer are extended in the opposite first direction and second direction, respectively.

12. The electrochromic panel of claim 11, wherein the third straight portions of the third mesh electrodes of the first conductive layer respectively have a width W31 and a width W32 in the first direction, and W21+W22>W31+W32.

13. The electrochromic panel of claim 11, wherein a resistance value of the first mesh electrode of the first conductive layer is R1, a resistance value of the second mesh electrodes of the first conductive layer is R2, and
$$\frac{\vert R 1 - R 2 \vert}{R 1} < 15 \% .$$

14. The electrochromic panel of claim 11, wherein the first straight portion of the first mesh electrode of the first conductive layer is extended in a third direction, the first mesh electrode of the second conductive layer has a width y in the third direction, and the first mesh electrode of the second conductive layer has a width x in the first direction, and 17 cm²≤x·y≤55 cm².

15. The electrochromic panel of claim 11, wherein the electrochromic layer has a sheet resistance value R_{EC}, and
$$20 \frac{Ohm}{S Q} \leq {R}_{E C} \leq 100 \frac{Ohm}{S Q} .$$
